(19) United States
(12) Patent Application Publication
(10) Pub. No.: US 2021/0241279 A1
(43) Pub. Date: Aug. 5, 2021

(54) AUTOMATIC FRAUD DETECTION

(71) Applicant: International Business Machines Corporation, Armonk, NY (US)

(72) Inventors: Willie R. Patten, Jr., Hurdle Mills, NC (US); Eugene I. Kelton, Mechanicsburg, PA (US)

(21) Appl. No.: 16/782,790

(22) Filed: Feb. 5, 2020

(51) Int. Cl. G06Q 20/40; G06N 3/04; G06F 16/21; G06F 17/15; G06N 3/12; G06K 9/62

(52) U.S. Cl. CPC G06Q 20/4016; G06N 3/04; G06K 9/6256; G06F 17/15; G06N 3/126; G06F 16/211

(57) ABSTRACT

Embodiments provide a computer implemented method, including: ingesting, by the processor, a data file including financial transaction data; generating, by the processor, a schema from the financial transaction data; identifying, by the processor, a data type of each data field in the schema; performing, by the processor, feature selection to select a plurality of data fields from the schema; performing, by the processor, data sampling to select candidate rows of the schema based on the selected data fields; clustering, by the processor, the sampled data to different categories; selecting, by the processor, a set of analytical models for risk prediction, wherein each analytical model corresponds to a data type of each selected data field, and each analytical model generates a risk score; and generating, by the processor, a single risk score indicating the fraud risk by combining all the risk scores generated by the set of analytical models.

### TECHNICAL FIELD

The present application generally relates to a system and method that can be used to automatically detect fraud based on a schema and data characteristics of the schema.

### BACKGROUND

Data analysis for fraud detection requires knowledge of data fields, data in these data fields, and types of analysis using various detection techniques. Thus, the current fraud detection project needs a business analyst to help quantify what the data fields are and the meaning of each data field. It also needs a data scientist to inspect the data in these data fields to identify analytical models that are fit for these data fields. Once the data fields and analytical models are determined, the data scientist can then implement the collection of indicators (i.e., features) and perform the appropriate analysis.

This is a typical process of any machine learning or data analysis project. This process requires a fair amount of manual effort, as well as experienced business analysts and data scientists.

### SUMMARY

Embodiments provide a computer implemented method, in a data processing system comprising a processor and a memory comprising instructions which are executed by the processor to cause the processor to implement an automatic fraud detection system for identifying a fraud risk, the method comprising: ingesting, by the processor, a data file including financial transaction data; generating, by the processor, a schema from the financial transaction data; identifying, by the processor, a data type of each data field in the schema; performing, by the processor, feature selection to select a plurality of data fields from the schema; performing, by the processor, data sampling to select candidate rows of the schema based on the selected data fields; clustering, by the processor, the sampled data into different categories; selecting, by the processor, a set of analytical models for risk prediction, wherein each analytical model corresponds to a data type of each selected data field, and each analytical model generates a risk score; and generating, by the processor, a single risk score indicating the fraud risk by combining all the risk scores generated by the set of analytical models.

Embodiments further provide a computer implemented method, wherein the data file is a spreadsheet, and the schema is generated based on a plurality of column names of the spreadsheet.

Embodiments further provide a computer implemented method, wherein a data type of timestamp corresponds to a chronological analytical model; a data type of string corresponds to an unstructured data analytical model; a data type of Uniform Resource Locator (URL) corresponds to Domain Name System (DNS) validation analytical model; a data type of an address corresponds to a geospatial analytical model; a data type of a person's name corresponds to identity resolution analytical model; and a data type of an account identifier corresponds to an account takeover detection analytical model.

Embodiments further provide a computer implemented method, further comprising: performing, by the processor, data correlation to identify the plurality of data fields correlated to each other; and selecting, by the processor, the plurality of data fields correlated to each other.

Embodiments further provide a computer implemented method, wherein the data sampling is stratified sampling.

Embodiments further provide a computer implemented method, further comprising: clustering, by the processor, the sampled data to different categories through a hierarchical clustering approach.

Embodiments further provide a computer implemented method, wherein the set of analytical models are selected from a common set of machine learning models including: a regression and classification tree; a dimensionality reduction model; a classical feedforward neural network; a bagging ensemble; a boosting ensemble; an quantum-inspired evolutionary algorithm, a particle-swarm optimization; Morse-Smale clustering, a Mapper algorithm, etc.; a gradient-based optimization model; a network metrics model; a convolution and pooling layer in a deep learning architecture; and a Bayesian network.

In another illustrative embodiment, a computer program product comprising a computer usable or readable medium having a computer readable program is provided. The computer readable program, when executed on a processor, causes the processor to perform various ones of, and combinations of, the operations outlined above with regard to the method illustrative embodiment.

In yet another illustrative embodiment, a system is provided. The system may comprise a full question generation processor configured to perform various ones of, and combinations of, the operations outlined above with regard to the method illustrative embodiment.

Additional features and advantages of this disclosure will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 depicts a schematic diagram of one illustrative embodiment of a cognitive system 100 implementing automatic fraud detection system in a computer network;

FIG. 2 depicts a schematic diagram of one illustrative embodiment of the automatic fraud detection system 110, according to embodiments described herein;

FIG. 3 illustrates a flowchart diagram depicting a method 300 of automatically detecting fraud from financial data, according to embodiments described herein; and

FIG. 4 is a block diagram of an example data processing system 400 in which aspects of the illustrative embodiments are implemented.

### DETAILED DESCRIPTION OF EXEMPLARY EMBODIMENTS

The present invention may be a system, a method, and/or a computer program product implemented on a cognitive system. The computer program product may include a computer readable storage medium (or media) having computer readable program instructions thereon for causing a processor to carry out aspects of the present invention.

As an overview, a cognitive system is a specialized computer system, or set of computer systems, configured with hardware and/or software logic (in combination with hardware logic upon which the software executes) to emulate human cognitive functions. These cognitive systems apply human-like characteristics to conveying and manipulating ideas which, when combined with the inherent strengths of digital computing, can solve problems with high accuracy and resilience on a large scale. IBM Watson is an example of one such cognitive system which can process human-readable language and identify inferences between text passages with human-like accuracy at speeds far faster than human beings and on a much larger scale. In general, such cognitive systems can perform the following functions:
Navigate the complexities of human language and understanding
Ingest and process vast amounts of structured and unstructured data
Generate and evaluate hypotheses
Weigh and evaluate responses that are based only on relevant evidence
Provide situation-specific advice, insights, and guidance
Improve knowledge and learn with each iteration and interaction through machine learning processes
Enable decision making at the point of impact (contextual guidance)
Scale in proportion to the task
Extend and magnify human expertise and cognition
Identify resonating, human-like attributes and traits from natural language
Deduce various language-specific or agnostic attributes from natural language
High degree of relevant recollection from data points (images, text, voice) (memorization and recall)
Predict and sense with situation awareness that mimic human cognition based on experiences
Answer questions based on natural language and specific evidence

In one aspect, the cognitive system can be augmented with an automatic fraud detection system. This automatic fraud detection system is intended to eliminate the need to have a detailed understanding of the data fields and data thereof through manual effort. In an embodiment, the automatic fraud detection system can leverage a schema, data types in the schema, and a correlation between data fields to automatically select appropriate analytical models from a set of analytical models, without any manual effort.

In an embodiment, the automatic fraud detection system can identify which analytical models are fit for data in the data fields and perform an analysis using the selected analytical models on these data fields, e.g.; date/time fields, numeric fields, text fields, etc.

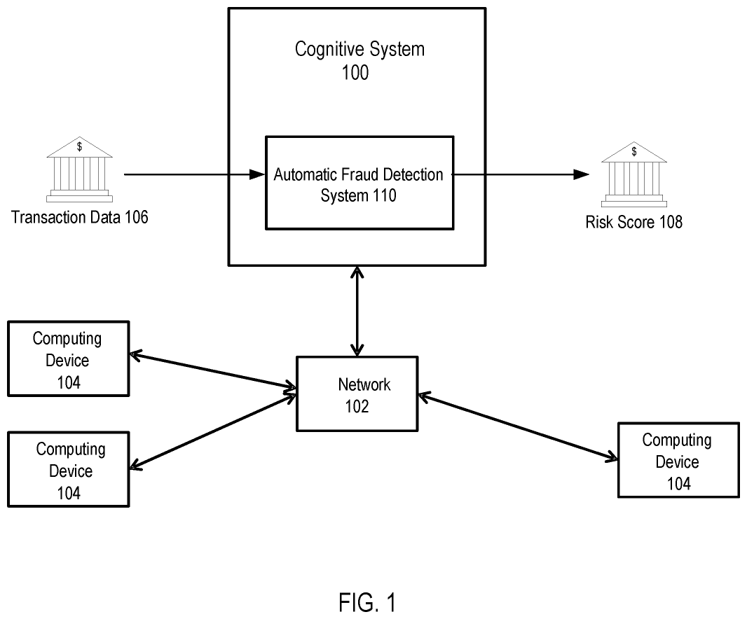

FIG. 1 depicts a schematic diagram of one illustrative embodiment of a cognitive system 100 implementing automatic fraud detection system 110 in a computer network 102. The cognitive system 100 is implemented on one or more computing devices 104 (comprising one or more processors and one or more memories, and potentially any other computing device elements generally known in the art including buses, storage devices, communication interfaces, and the like) connected to the computer network 102. The computer network 102 includes multiple computing devices 104 in communication with each other and with other devices or components via one or more wired and/or wireless data communication links, where each communication link comprises one or more of wires, routers, switches, transmitters, receivers, or the like. Other embodiments of the cognitive system 100 may be used with components, systems, sub-systems, and/or devices other than those that are depicted herein. The computer network 102 includes local network connections and remote connections in various embodiments, such that the cognitive system 100 may operate in environments of any size, including local and global, e.g., the Internet. The cognitive system 100 is configured to implement automatic fraud detection system 110 that can automatically identify transaction data involving financial fraud from a large amount of transaction data 106. The automatic fraud detection system 110 can generate a risk score 108, indicating a risk of fraud. The automatic fraud detection system 110 can automatically identify data fields and related data characteristics (e.g., whether a data field can contain an empty value; a data type of each data field, etc.) without the involvement of business analysts and data scientists.

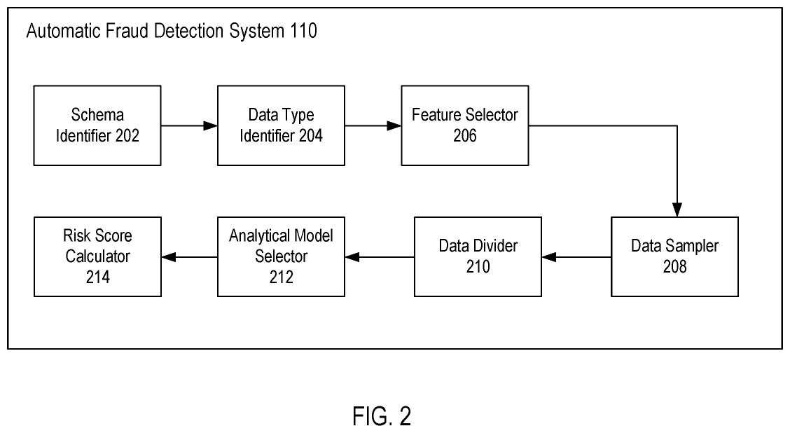

FIG. 2 depicts a schematic diagram of one illustrative embodiment of the automatic fraud detection system 110, according to embodiments described herein. As shown in FIG. 2, the automatic fraud detection system 110 includes schema identifier 202, data type identifier 204, feature selector 206, data sampler 208, data divider 210, analytical model selector 212, and risk score calculator 214. The schema identifier 202 is configured to identify a schema from the input transaction data 106. The data type identifier 204 is configured to identify a data type of each data field in the schema. The feature selector 206 is configured to select data fields of the schema for later risk prediction. The data sampler 208 is configured to select candidate rows of the schema based on the selected data fields, so that a small and manageable amount of transaction data is selected for later risk prediction. The data divider 210 is configured to cluster the selected transaction data into different categories. The analytical model selector 212 is configured to select one or more analytical models for risk prediction. The risk score calculator 214 is configured to combine all the risk scores calculated by each analytical model and convert into a single risk score indicating risk of fraud.

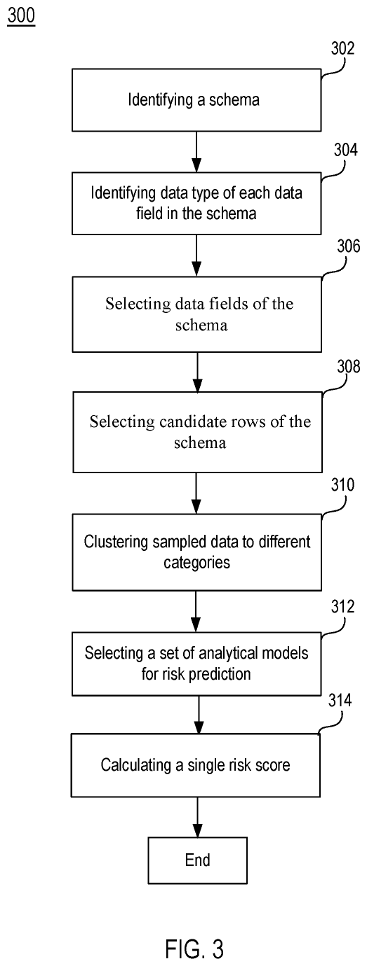

FIG. 3 illustrates a flowchart diagram depicting a method 300 of automatically detecting fraud from financial data, according to embodiments described herein. At step 302, a data file containing, e.g., financial transaction data, is input to identify a schema. A schema is composed of all attributes in the input data and their corresponding data types. For example, the schema can be inferred from the column names of a spreadsheet (the data file is a spreadsheet) and data type of each column. The schema can be further enriched. For example, the schema may include ten data fields (i.e., ten columns), and one of the ten data fields is a “date” field. The “date” field can be defined as “the day of the week” of a transaction for schema enrichment. Each data file can correspond to one schema. For example, a schema can be inferred from a data file containing ATM transaction data, and another schema can be inferred from a data file containing Bank Wire Transfer transaction data. One or more schemas are then used to determine the appropriate analytical models for risk assessment.

At step 304, different data types are identified from the schema for each data field. Analytical models can be determined based on data characteristics, e.g., data types, such as integer, decimal, real, string, timestamp, etc. For instance, numerical data can be the transaction amount (a real number, e.g., a real number containing a decimal), day of a week (an integer/whole number), age of a person, etc. If a data field consisting of numerical data has a discrete set of numbers, then the data field can be considered as a categorization field or classification field, and thus a categorical model is needed. Time-based data can be a set of transactions daily, or in several months or years. The time-based data can indicate a trend of time when those transactions occur (e.g., salaries are generally paid monthly). The string data may be used to determine a proper classification or categorization. Specifically, if a data field consisting of a string has a finite set of values, for instance, the data field “Line_of_Business” has six discrete values, then the data field “Line_of_Business” can be considered as a categorization field or classification field. For another example, the data field “Gender” has two discrete values, then the data field “Gender” can be considered as a categorization field or classification field. For another example, a timestamp can be used to determine the data field “Day of the Week” of a transaction. The data field “Day of the Week” has seven discrete values, and can be used as a categorization field or classification field. Different data types indicate an automatic selection of analytical models that can be performed on these different data fields. For example, a timestamp or a date stamp may indicate a chronological analysis; a text or a string may indicate an unstructured data analysis; a numerical data field may indicate a monetary analysis; Uniform Resource Locator (URL) may indicate Domain Name System (DNS) validation; an address may indicate geospatial analysis; a person's name may indicate identity resolution approach; account identifiers (bank accounts, insurance policy, online IDs, etc.) may indicate account takeover detection. The types of analytical models are determined based on a plurality of data fields, or a combination of data fields and the name of each field (if applicable).

At step 306, feature selection is performed to select data fields of the schema. Feature selection is a process to select features that contribute most to risk prediction. The selected features can be, e.g., the day of the week based on the transaction date, an average amount of a transaction, a geographic area based on one or more addresses, the number of transactions per month, etc.

Data correlation is performed to understand the relationship among multiple attributes (i.e., data fields) in the schema, and identify which data fields have the greatest chance of being “interesting” in combination. These data fields having the greatest chance of being “interesting” in combination can be selected. From a perspective of data science, the chance of being “interesting” in combination is determined by a correlation between two data fields. For example, there are two data fields, i.e., data field A and data field B. If changes of the data field A do not affect the data field B, then a combination of these two data fields is not “interesting.” For instance, the data field A represents the date of a deposit or withdrawal, and the data field B represents the age of a person. The date of a withdrawal/deposit is not affected by the age of a person, and thus a combination of these two data fields is not “interesting.” By contrast, if changes in the data field A affect the data field B, then a combination of these two fields is deemed to be “interesting.” For instance, the data field A represents the age of a person, and the data field B represents the salary of this person. There could be a correlation between the age and the salary, and thus a combination of these two fields is “interesting.” Accordingly, the data field A and the data field B can be used in a data analysis that can lead to “interesting” results.

At step 308, data sampling is performed to select candidate rows of the schema based on the selected data fields (selected columns of the schema). Data sampling is a statistical analysis technique used to select, manipulate, and analyze a representative subset of data points to identify patterns and trends in a larger data set being examined. It enables the analytical models to work with a small and manageable amount of data about a statistical population, so that the analytical models can be run more quickly while still performing accurate predictions. In an embodiment, stratified sampling is performed so that the schema data can be proportionally represented. To detect financial fraud, e.g., money laundering, etc., the representative subset of schema data needs to include a certain amount of transaction data involving financial fraud to avoid bias.

At step 310, the sampled data (i.e., selected candidate rows of the schema) is clustered or bucketed to different categories. For example, a hierarchical clustering approach can be used to divide transaction data into a male group and a female group. Then, each group may be further clustered into different clusters based on salary ranges. The rules of clustering are flexible. For example, transaction data can be clustered based on the transaction date, e.g., every Wednesday, or in October, etc. The transaction data can be clustered based on the originating country of a transaction, or the destination country of a transaction. The transaction data can be clustered based on the number of transactions, e.g., the total number of transactions less than 5000. The transaction data can be clustered based on the transaction amount, e.g., the average monthly transaction amount more than $2000. Different clustering algorithms, such as hierarchical clustering, k-means clustering, Morse-Smale clustering, spectral clustering, etc., can be applied at step 310.

At step 312, a selected set of analytical models are used to perform data analysis on the clustered data. Each selected analytical model can generate a risk score. Analytical models are selected from a common set of machine learning models, including but not limited to: regression and classification trees (early extension of generalized linear models with high accuracy, good interpretability, and low computational expense); dimensionality reduction, such as principal component analysis (PCA), and manifold learning approaches like Multi-dimensional Scaling (MDS) and t-Distributed Stochastic Neighbor Embedding (tSNE), etc.; classical feedforward neural networks; bagging ensembles which form a basis of algorithms like random forest and K-nearest-neighbor (KNN) regression ensembles, etc.; boosting ensembles which form a basis of gradient boosting and XGBoost algorithms; optimization algorithms for parameter tuning or design projects, such as genetic algorithms, quantum-inspired evolutionary algorithms, simulated annealing, particle-swarm optimization, etc.; topological data analysis tools which are particularly well-suited for unsupervised learning on small sample sizes, such as persistent homology, Morse-Smale clustering, Mapper algorithm, etc.; deep learning architectures; KNN approaches for local modeling (regression, classification); gradient-based optimization methods; network metrics and algorithms, such as centrality measures, betweenness, diversity, entropy, Laplacians, epidemic spread, spectral clustering, etc.; convolution and pooling layers in deep architectures, which are particularly useful in computer vision and image classification models; hierarchical clustering (which is related to both k-means clustering and topological data analysis tools); Bayesian networks (pathway mining); complexity and dynamic systems, which are related to differential equations but often used to model systems without a known driver.

Some general rules can be used to identify which analytical model(s) may provide better results. For instance, a supervised model that uses a random forest technique generally provides better results than an unsupervised model that uses only a statistical comparison (e.g., page ranking). The data types of selected data fields also can be used to identify analytical model(s) for data analysis. For example, a timestamp or a date stamp may indicate a chronological analysis; a text or a string may indicate an unstructured data analysis; a numerical data field may indicate a monetary analysis; Uniform Resource Locator (URL) may indicate Domain Name System (DNS) validation; an address may indicate geospatial analysis; a person's name may indicate identity resolution approach; account identifiers (bank accounts, insurance policy, online IDs, etc.) may indicate account takeover detection.

At step 314, all the risk scores are combined and converted into a single risk score indicating a risk of fraud. In an embodiment, the automatic fraud detection system can aggregate results of the analysis to perform an ensemble rollup of the results, producing a single risk score. The risk score can then be converted into a risk of fraud assessment. In an embodiment, a maximum score is selected among all the risk scores, and used as the single risk score. In another embodiment, an average score of all the risk scores can be computed and used as the single risk score. In another embodiment, a weight can be assigned for each risk score when calculating the single risk score. In another embodiment, all the risk scores can be converted into a single risk score using other techniques, such as normalization, etc. The single risk score is compared to a predefined threshold to determine the risk of fraud. For example, if the single risk score is less than 0.2, then the risk of fraud is low; if the single risk score is more than 0.2 and less than 0.65, then the risk of fraud is medium; and if the single risk score is more than 0.65, then the risk of fraud is high.

The system, method, and computer product of automatic fraud detection can automatically understand the available data fields, data characteristics of data in the data fields, and the most obvious/interesting data field combinations on which to perform data analysis. The system, method, and computer product of automatic fraud detection can eliminate the need for detailed human understanding before data analysis for fraud risk prediction. Thus, data analysis can be performed without the long lead time of business analyst and data scientist understanding.

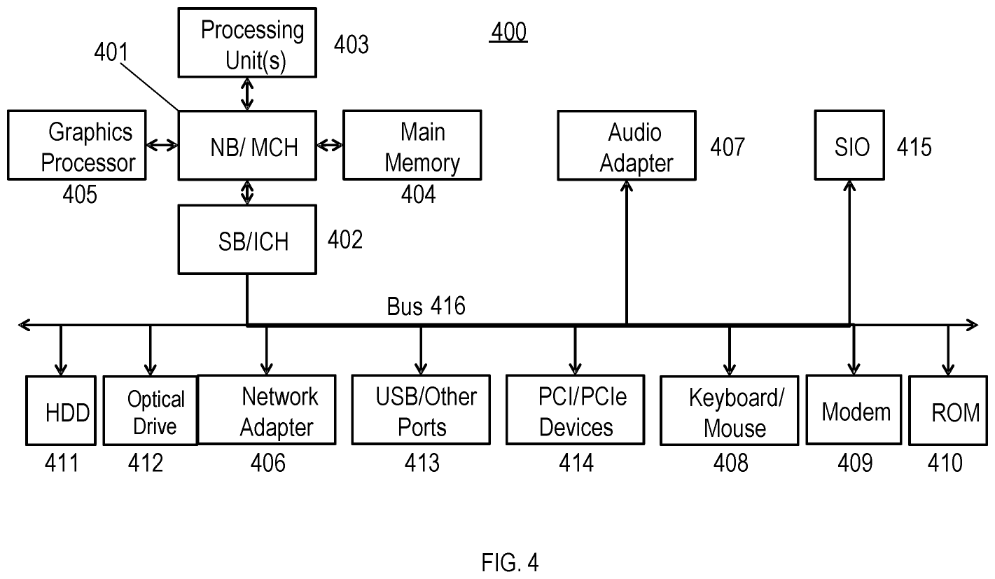

FIG. 4 is a block diagram of an example data processing system 400 in which aspects of the illustrative embodiments are implemented. Data processing system 400 is an example of a computer, such as a server or a client, in which computer usable code or instructions implementing the process for illustrative embodiments of the present invention are located. In one embodiment, FIG. 4 represents a server computing device, such as a server, which implements the automatic fraud detection system 110 and cognitive system 100 described herein.

In the depicted example, the data processing system 400 can employ a hub architecture including a north bridge and memory controller hub (NB/MCH) 401 and south bridge and input/output (I/O) controller hub (SB/ICH) 402. Processing unit 403, main memory 404, and graphics processor 405 can be connected to the NB/MCH 401. Graphics processor 405 can be connected to the NB/MCH 401 through an accelerated graphics port (AGP).

In the depicted example, the network adapter 406 connects to the SB/ICH 402. The audio adapter 407, keyboard and mouse adapter 408, modem 409, read-only memory (ROM) 410, hard disk drive (HDD) 411, optical drive (CD or DVD) 412, universal serial bus (USB) ports and other communication ports 413, and the PCI/PCIe devices 414 can connect to the SB/ICH 402 through bus system 416. PCI/PCIe devices 414 may include Ethernet adapters, add-in cards, and PC cards for notebook computers. ROM 410 may be, for example, a flash basic input/output system (BIOS). The HDD 411 and optical drive 412 can use an integrated drive electronics (IDE) or serial advanced technology attachment (SATA) interface. The super I/O (SIO) device 415 can be connected to the SB/ICH.

An operating system can run on processing unit 403. The operating system can coordinate and provide control of various components within the data processing system 400. As a client, the operating system can be a commercially available operating system. An object-oriented programming system, such as the Java™ programming system, may run in conjunction with the operating system and provide calls to the operating system from the object-oriented programs or applications executing on the data processing system 400. As a server, the data processing system 400 can be an IBM® eServer™ System P® running the Advanced Interactive Executive operating system or the Linux operating system. The data processing system 400 can be a symmetric multiprocessor (SMP) system that can include a plurality of processors in the processing unit 403. Alternatively, a single processor system may be employed.

Instructions for the operating system, the object-oriented programming system, and applications or programs are located on storage devices, such as the HDD 411, and are loaded into the main memory 404 for execution by the processing unit 403. The processes for embodiments of the full question generation system can be performed by the processing unit 403 using computer usable program code, which can be located in a memory such as, for example, main memory 404, ROM 410, or in one or more peripheral devices.

A bus system 416 can be comprised of one or more busses. The bus system 416 can be implemented using any type of communication fabric or architecture that can provide for a transfer of data between different components or devices attached to the fabric or architecture. A communication unit such as the modem 409 or network adapter 406 can include one or more devices that can be used to transmit and receive data.

Those of ordinary skill in the art will appreciate that the hardware depicted in FIG. 4 may vary depending on the implementation. Other internal hardware or peripheral devices, such as flash memory, equivalent non-volatile memory, or optical disk drives may be used in addition to or in place of the hardware depicted. Moreover, the data processing system 400 can take the form of any of a number of different data processing systems, including but not limited to, client computing devices, server computing devices, tablet computers, laptop computers, telephone or other communication devices, personal digital assistants, and the like. Essentially, data processing system 400 can be any known or later developed data processing system without architectural limitation.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a head disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN) and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including LAN or WAN, or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operations steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical functions. In some alternative implementations, the functions noted in the block may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The present description and claims may make use of the terms “a,” “at least one of,” and “one or more of,” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the example provided herein without departing from the spirit and scope of the present invention.

The system and processes of the figures are not exclusive. Other systems, processes and menus may be derived in accordance with the principles of embodiments described herein to accomplish the same objectives. It is to be understood that the embodiments and variations shown and described herein are for illustration purposes only. Modifications to the current design may be implemented by those skilled in the art, without departing from the scope of the embodiments. As described herein, the various systems, subsystems, agents, managers, and processes can be implemented using hardware components, software components, and/or combinations thereof. No claim element herein is to be construed under the provisions of 35 U.S.C. 112, sixth paragraph, unless the element is expressly recited using the phrase “means for.”

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

What is claimed is:

1. A computer implemented method, in a data processing system comprising a processor and a memory comprising instructions which are executed by the processor to cause the processor to implement an automatic fraud detection system for identifying a fraud risk, the method comprising:
ingesting, by the processor, a data file including financial transaction data;
generating, by the processor, a schema from the financial transaction data;
identifying, by the processor, a data type of each data field in the schema;
performing, by the processor, feature selection to select a plurality of data fields from the schema;
performing, by the processor, data sampling to select candidate rows of the schema based on the selected data fields;
clustering, by the processor, the sampled data into different categories;
selecting, by the processor, a set of analytical models for risk prediction, wherein each analytical model corresponds to a data type of each selected data field, and each analytical model generates a risk score; and
generating, by the processor, a single risk score indicating the fraud risk by combining all the risk scores generated by the set of analytical models.

2. The method as recited in claim 1, wherein the data file is a spreadsheet, and the schema is generated based on a plurality of column names of the spreadsheet.

3. The method as recited in claim 1, wherein a data type of timestamp corresponds to a chronological analytical model; a data type of string corresponds to an unstructured data analytical model; a data type of Uniform Resource Locator (URL) corresponds to Domain Name System (DNS) validation analytical model; a data type of an address corresponds to a geospatial analytical model; a data type of a person's name corresponds to identity resolution analytical model; and a data type of an account identifier corresponds to an account takeover detection analytical model.

4. The method as recited in claim 1, further comprising:
performing, by the processor, data correlation to identify the plurality of data fields correlated to each other; and
selecting, by the processor, the plurality of data fields correlated to each other.

5. The method as recited in claim 1, wherein the data sampling is stratified sampling.

6. The method as recited in claim 1, further comprising: clustering, by the processor, the sampled data to different categories through a hierarchical clustering approach.

7. The method as recited in claim 1, wherein the set of analytical models are selected from a common set of machine learning models including: a regression and classification tree; a dimensionality reduction model; a classical feedforward neural network; a bagging ensemble; a boosting ensemble; an quantum-inspired evolutionary algorithm, a particle-swarm optimization; Morse-Smale clustering, a Mapper algorithm, etc.; a gradient-based optimization model; a network metrics model; a convolution and pooling layer in a deep learning architecture; and a Bayesian network.

8. A computer program product for automatic fraud detection, the computer program product comprising a computer readable storage medium having program instructions embodied therewith, the program instructions executable by a processor to cause the processor to:
ingest a data file including financial transaction data;
generate a schema from the financial transaction data;
identify a data type of each data field in the schema;
perform feature selection to select a plurality of data fields from the schema;
perform data sampling to select candidate rows of the schema based on the selected data fields;
cluster the sampled data into different categories;
select a set of analytical models for risk prediction, wherein each analytical model corresponds to a data type of each selected data field, and each analytical model generates a risk score; and
generate a single risk score indicating the fraud risk by combining all the risk scores generated by the set of analytical models.

9. The computer program product as recited in claim 8, wherein the data file is a spreadsheet, and the schema is generated based on a plurality of column names of the spreadsheet.

10. The computer program product as recited in claim 8, wherein a data type of timestamp corresponds to a chronological analytical model; a data type of a numerical number corresponds to a monetary analytical model; a data type of Uniform Resource Locator (URL) corresponds to Domain Name System (DNS) validation analytical model; a data type of an address corresponds to a geospatial analytical model; a data type of a person's name corresponds to identity resolution analytical model; and a data type of an account identifier corresponds to an account takeover detection analytical model.

11. The computer program product as recited in claim 8, wherein the processor is further caused to perform data correlation to identify the plurality of data fields correlated to each other; and select the plurality of data fields correlated to each other.

12. The computer program product as recited in claim 8, wherein the data sampling is stratified sampling.

13. The computer program product as recited in claim 8, wherein the processor is further caused to cluster the sampled data to different categories through a hierarchical clustering approach.

14. The computer program product as recited in claim 8, wherein the set of analytical models are selected from a common set of machine learning models including: a regression and classification tree; a dimensionality reduction model; a classical feedforward neural network; a bagging ensemble; a boosting ensemble; an quantum-inspired evolutionary algorithm, a particle-swarm optimization; Morse-Smale clustering, a Mapper algorithm, etc.; a gradient-based optimization model; a network metrics model; a convolution and pooling layer in a deep learning architecture; and a Bayesian network.

15. A system for identifying a fraud risk, comprising:
a processor configured to:
ingest a data file including financial transaction data;
generate a schema from the financial transaction data;
identify a data type of each data field in the schema;
perform feature selection to select a plurality of data fields from the schema;
perform data sampling to select candidate rows of the schema based on the selected data fields;
cluster the sampled data into different categories;
select a set of analytical models for risk prediction, wherein each analytical model corresponds to a data type of each selected data field, and each analytical model generates a risk score; and
generate a single risk score indicating the fraud risk by combining all the risk scores generated by the set of analytical models.

16. The system as recited in claim 15, wherein the data file is a spreadsheet, and the schema is generated based on a plurality of column names of the spreadsheet.

17. The system as recited in claim 15, wherein a data type of time stamp corresponds to a chronological analytical model; a data type of string corresponds to an unstructured data analytical model; a data type of Uniform Resource Locator (URL) corresponds to Domain Name System (DNS) validation analytical model; a data type of an address corresponds to a geospatial analytical model; a data type of a person's name corresponds to identity resolution analytical model; and a data type of an account identifier corresponds to an account takeover detection analytical model.

18. The system as recited in claim 15, wherein the processor is further configured to perform data correlation to identify the plurality of data fields correlated to each other; and select the plurality of data fields correlated to each other.

19. The system as recited in claim 15, wherein the data sampling is stratified sampling.

20. The system as recited in claim 15, wherein the set of analytical models are selected from a common set of machine learning models including: a regression and classification tree; a dimensionality reduction model; a classical feedforward neural network; a bagging ensemble; a boosting ensemble; an quantum-inspired evolutionary algorithm, a particle-swarm optimization; Morse-Smale clustering, a Mapper algorithm, etc.; a gradient-based optimization model; a network metrics model; a convolution and pooling layer in a deep learning architecture; and a Bayesian network.
